(19) United States
(12) Patent Application Publication
(10) Pub. No.: US 2018/0083243 A1
(43) Pub. Date: Mar. 22, 2018

(54) BATTERY HOUSING FOR A TRACTION BATTERY

(71) Applicant: Dr. Ing. h.c. F. Porsche Aktiengesellschaft, Stuttgart (DE)

(72) Inventors: Stephan Brausse, Eningen (DE); Thorsten BECKER, Vaihingen an der Enz (DE)

(73) Assignee: Dr. Ing. h.c. F. Porsche Aktiengesellschaft, Stuttgart (DE)

(21) Appl. No.: 15/704,970

(22) Filed: Sep. 14, 2017

(30) Foreign Application Priority Data
Sep. 16, 2016 (DE) 102016117442.4

(51) Int. Cl. H01M 2/10

(52) U.S. Cl. CPC H01M 2/1083; H01M 2220/20; H01M 2/1094

(57) ABSTRACT

A battery housing for receiving a traction battery has a battery housing part and a cover which together define a receiving region for the traction battery. The cover has a contact surface, and the battery housing part has a contact counter surface, which contact surface and contact counter surface lie against each other in a contact region. A shielding part is provided which extends into a shielding region, which shielding region is arranged between the receiving region and the contact region in order to bring about shielding there. A riveting nut is used to fasten the cover to the battery housing part.

### CROSS-REFERENCE TO RELATED APPLICATIONS

This application claims priority to German Patent Application No. 10 2016 117 442.4, filed Sep. 16, 2016, the content of such application being incorporated by reference herein in its entirety.

### FIELD OF THE INVENTION

The invention relates to a battery housing for a traction battery.

### BACKGROUND OF THE INVENTION

In modern electric vehicles which are driven with electrical energy, i.e. for example, motor vehicles, rail vehicles or watercraft, the drive energy is frequently stored in traction batteries in the vehicle. Traction batteries are energy accumulators which serve for driving electric vehicles, and they are also referred to as drive batteries. They are preferably high voltage batteries and are customarily assigned electronic components which generate electromagnetic waves. Said electromagnetic waves are intended to be shielded by the battery housing.

DE 10 2013 112 413 A1, which is incorporated by reference herein, presents a housing for a traction battery. A flat element composed of a magnetically soft material is provided in order to permit effective shielding against electromagnetic radiation and magnetic alternating fields.

DE 10 2012 004 135 A1, which is incorporated by reference herein, presents a battery box for a traction battery with an upper shell and a lower shell which are connected to each other. Means for increasing the electromagnetic compatibility are provided, in particular fastening clips.

DE 10 2013 021 173 A1, which is incorporated by reference herein, presents a housing for a battery and a method for installing such a housing. In the connecting region, housing parts are connected mechanically and electrically to one another by means of an elastic pretensioning force.

DE 10 2011 052 513 A1, which is incorporated by reference herein, presents a battery housing part for receiving a traction battery of an electric vehicle. A cavity is provided in the wall of the battery housing part.

### SUMMARY OF THE INVENTION

Described herein is a battery housing for receiving a traction battery, which battery housing comprises a battery housing part and a cover which together define a receiving region for the traction battery, which cover has a contact surface, and which battery housing part has a contact counter surface, which contact surface and contact counter surface lie against each other in a contact region, wherein a shielding part is provided which extends into a shielding region, which shielding region is arranged between the receiving region and the contact region in order to bring about shielding there.

Good shielding of the battery housing is obtained by the shielding part.

According to a preferred embodiment, the shielding part is formed at least in regions from a metallic material. This improves the shielding.

According to preferred embodiments, the shielding part is fixedly connected to the cover or to the battery housing part. The installation of the shielding part is thereby greatly simplified.

According to a preferred embodiment, the shielding part is electrically conductively connected to the battery housing, for example by a connection to the battery housing part and/or to the cover. This improves the shielding.

Also described herein is a battery housing for receiving a traction battery, which battery housing comprises a battery housing part and a cover which together define a receiving region for the traction battery, wherein at least one riveting nut with a head and a tubular region is provided, which riveting nut is fastened to the battery housing part and is electrically conductively connected thereto, and wherein the cover is fastened to the battery housing part via a screw fastened to the riveting nut.

The use of a riveting nut has proven highly advantageous since the production of an electrically conductive connection on the battery housing is frequently difficult, in particular when there is a coating. The installation of the riveting nut is straightforward, and an electrical connection can be produced.

So According to preferred embodiments, the riveting nut has projections, by means of which electrical contact with the surrounding components can be improved.

According to a preferred embodiment, the battery housing has both a riveting nut and a shielding part. This permits a good electrical connection between the battery housing part, the cover and the shielding part and leads to good shielding.

According to a preferred embodiment, the battery housing part and the cover have a metallic material. The battery housing can therefore act as a Faraday cage and shield against electromagnetic radiation.

### BRIEF DESCRIPTION OF THE DRAWINGS

Further details and advantageous developments of the invention emerge from the exemplary embodiments which are described below and are illustrated in the drawing but should in no way be understood as a restriction of the invention, and from the dependent claims. In the drawing,

FIG. 1 shows, in a sectional illustration, a battery housing with a battery,

FIG. 2 shows a side view of the battery housing from FIG. 1 from the direction of the arrow II,

FIG. 3 shows, in a sectional illustration, a riveting nut arranged on the battery housing of FIG. 1,

FIG. 4 shows, in a sectional illustration, a riveting nut pressed on the battery housing of FIG. 1,

FIG. 5 shows, in a sectional illustration, a battery housing closed by the riveting nut of FIG. 4,

FIG. 6 shows, in a sectional illustration along the intersecting line VI-VI from FIG. 3, an advantageous embodiment of the riveting nut, and

FIG. 7 shows, in a sectional illustration along the intersecting line VI-VI from FIG. 3, a further advantageous embodiment of the riveting nut.

### DETAILED DESCRIPTION OF THE INVENTION

In the description below of the figures, parts which are identical or act in an identical manner are denoted by the same reference signs and are customarily only described once.

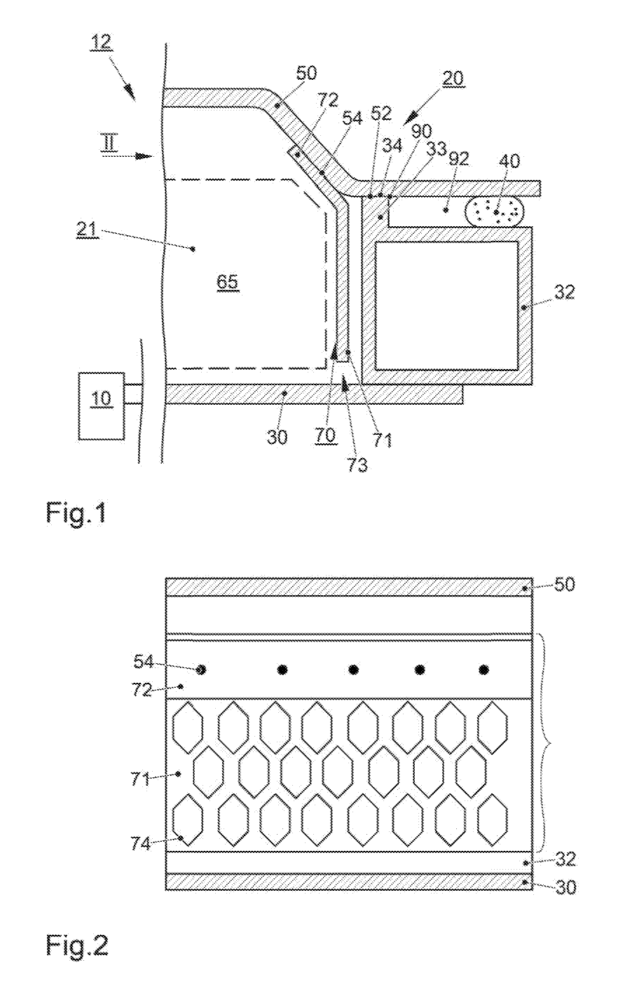

FIG. 1 shows a battery housing 20 which has a battery housing part 30, 32 and a cover 50 for the battery housing part 30, 32. A battery 65, in particular a rechargeable traction battery 65, as has been described above, is arranged in the battery housing part 30, 32.

The battery housing part 30, 32 is connected to a schematically indicated body 10 of a vehicle 12 and is preferably located in the central region of the vehicle 12.

In the exemplary embodiment, the battery housing part 30, 32 has a base part 30, which may also be referred to as base plate 30, and an outer battery housing structure 32 which is connected to the latter and may also be referred to as battery structure 32. The battery housing structure 32 is preferably designed as an extruded profile, and it preferably has an end stop or spacer 33 against which the cover 50 lies. In more precise terms, the cover 50 has a contact surface 52, and the battery housing part 30, 32 has a contact counter surface 34. The contact surface 52 and the contact counter surface 34 are in contact with each other in a contact region 90.

The battery housing structure 32 and the base part 30 are connected to each other, for example, by a welded joint.

The cover 50 and the battery housing part 30, 32 in regions from a gap 92 in which, in the exemplary embodiment, an adhesive connection is provided with an adhesive 40 which connects the cover 50 and the battery housing part 30, 32 to each other. The gap 92 may therefore also be referred to as adhesive gap 92. The arrangement shown has the advantage that the adhesive 40 can be destroyed or removed in order to open the battery housing 20 by a sharp object, for example a knife, being moved through the gap 92 and the adhesive 40 being cut open. For the renewed closure, the battery housing 20 can be adhesively bonded again.

The width of the adhesive gap is, by way of example, 5 mm to 7 mm. The housing 20 is illustrated schematically, and the latter may be larger relative to the gap 92 than illustrated.

A shielding part 70 is provided between the contact region 90 and the interior of the battery housing 20, in which the battery 65 can be arranged. The shielding part 70 is preferably formed at least in regions from a metallic material.

In the exemplary embodiment, the shielding part 70 is fastened to the cover 50, and therefore installation of the cover 50 at the same time brings about a suitable arrangement of the shielding part 70.

In the same manner, the shielding part 70 can also be fastened to the battery housing part 30, 32 such that said shielding part shields the contact region 90.

In the exemplary embodiment, the shielding part 70 does not have any contact with the battery housing part 30, 32. However, contact can also be provided, and it is additionally possible to allow the shielding part 70 to lie resiliently against the battery housing part 30, 32 or—to allow said shielding part to lie resiliently against the cover 50 upon fastening to the battery housing part 30, 32.

The cover 50 is preferably formed from a metallic material, in particular from steel or aluminum or an alloy with one of said materials.

The housing part 30, 32 is preferably formed from a metallic material, in particular from aluminum or steel or an alloy with at least one of these materials.

When the cover 50 and the battery housing part 30, 32 are formed from a metallic material, they can form a Faraday cage in order thereby to permit good shielding of electromagnetic fields. This significantly improves the electromagnetic compatibility (EMC).

So FIG. 2 shows a side view of the shielding part 70 which is designed in the exemplary embodiment as a shielding plate. Such shielding plates are available in the form of strip material and can be trimmed to the desired length. The shielding part 70 has a first region 71 in which it is provided with recesses 74 in the manner of a perforated plate, and a second region 72 which is fastened to the cover 50. The fastening is undertaken via a welded joint, and the welding points 54 are shown by way of example. The shielding part 70 is preferably electrically conductively connected to the cover 50 and/or to the battery housing part 30, 32 in order to bring about effective shielding.

The shielding can be checked by the fact that the additional shielding damping produced by the shielding part 70 is determined. The aim is to prevent or at least to reduce the occurrence or penetration of electrical fields, magnetic fields and electromagnetic waves.

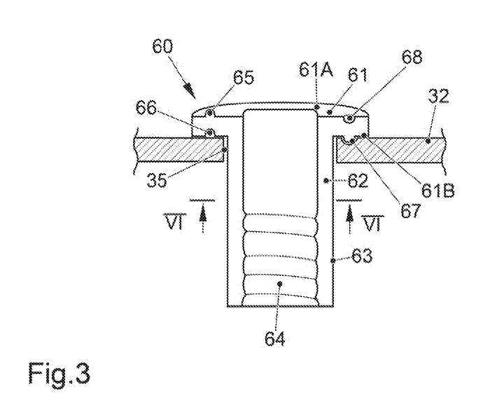

FIG. 3 shows a riveting nut 60 which is also referred to as a blind rivet nut.

The riveting nut 60 has a head 61 and a tubular region 62, 63, which tubular region 62, 63 has a deformable region 62 and a region 63 in which an internal thread 64 is provided.

On the head 61, a projection 65 is provided on the side opposite the tubular region 62, 63, and a projection 67 is provided on the side facing the tubular region 62, 63. The projections 65, 67 may also be referred to as spikes or sharp scrapers, and a plurality of projections 65, 67 can be provided in each case.

The projections 65, 67 can be produced, for example, by deformation by stamping, and depressions 66, 68 assigned to the projections 65, 67 are illustrated.

The riveting nut 60 is pushed into a cutout 35 of the battery housing part 30, 32, preferably in the region of the battery housing structure 32.

The cover 50 can be fastened in a preferred manner to the battery housing part 30, 32 by the riveting nut 60, as shown below.

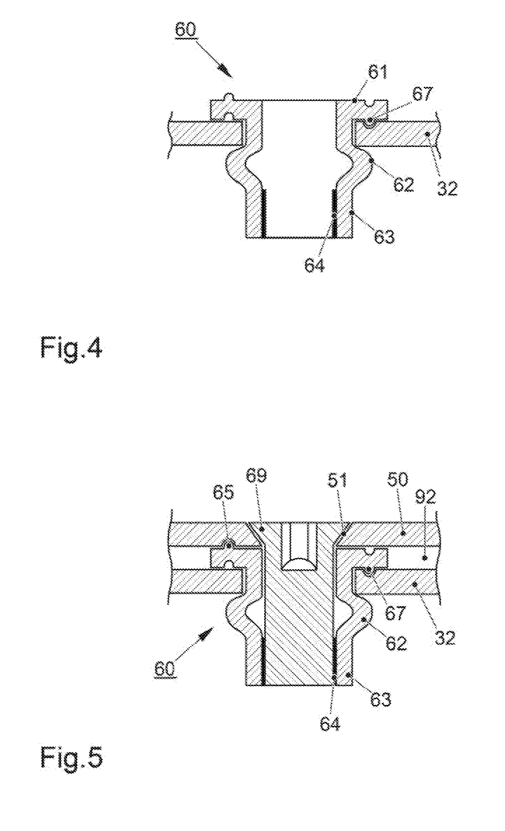

FIG. 4 shows the fastening of the riveting nut 60 to the battery housing part 30, 32. During the installation, the riveting nut 60 is pressed against the battery housing part 30, 32, and therefore the projection 67 penetrates the battery housing part 30, 32.

When the battery housing part 30, 32 and the riveting nut 60 are configured from a metallic material, this results in an electrically conductive connection.

The riveting nut 60 is deformed with a riveting tool (not illustrated) by the region 63 with the thread being drawn toward the head 61. By this means, a bead is formed on the deformable region 62 of the tubular region 62, 63, the bead leading to a fixed connection of the riveting nut 60 to the battery housing part 30, 32.

FIG. 5 shows the fastening of the cover 50 to the battery housing part 30, 32 with the aid of the riveting nut 60 and a screw 69.

The cover 50 is placed on, and a screw 69 is inserted into an opening 51 in the cover 50 and screwed to the riveting nut 60. The screwing causes the projection 65 to dig into the cover 50, and, when the cover 50 and the riveting nut 60 are formed from a metallic material, a good electrically conductive connection arises between the cover 50 and the riveting nut 60.

Overall, a good electrically conductive connection between the cover 50 and the battery housing part 30, 32 can thus be obtained via the riveting nut 60, even in the event of the battery housing part 30, 32 and/or the cover 50 being coated.

This is advantageous in particular of the body 10 of vehicles 12 is protected against corrosion by coating. A type of coating often used for this purpose is cathodic dip coating (CDC). This coating results in an electrically non-conductive or poorly conductive layer on the surfaces of the battery housing part 30, 32 and of the cover 50, which, without the projections 65, 67, would lead to an electrically poorly conductive contact. During the placing of the riveting nut 60 and the screwing thereof, the projections penetrate the coating layer and form a good electrical contact with the surrounding components.

In addition to the screw connection of the riveting nut 60, the adhesive 40 from FIG. 1 can be provided in the gap 92, either only in the region outside the riveting nut 60 or else also in the region of the riveting nut and/or within the latter.

If the gap 92 is larger than the thickness of the head 61, the cover 50 can be locally stamped in the corresponding region in order to bring about a suitable distance between the cover 50 and the battery housing part 30, 32.

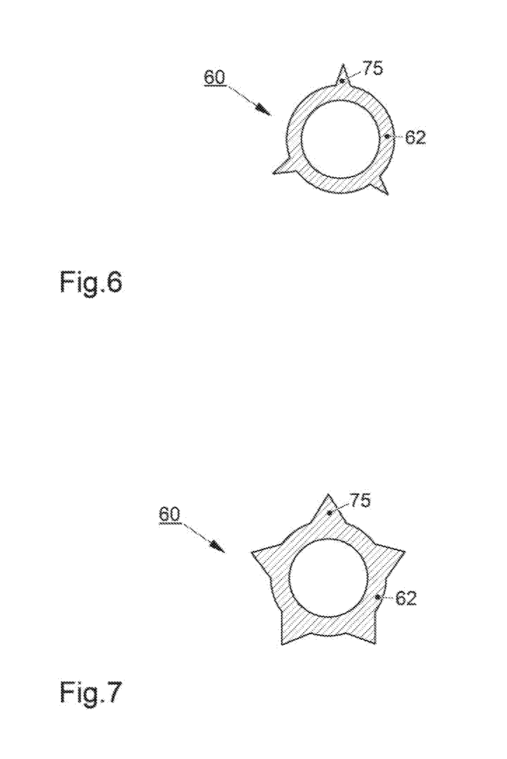

FIG. 6 shows a variant of the riveting nut 60, as seen in the direction of the intersecting line VI-VI of FIG. 3. Three projections 75 are provided on the outer side in the tubular region 62, 63, said projections extending along the outer side of the tubular region 62, 63 and acting as a cutting or scraping edge. The projections 75 are preferably located on the circumference of the tubular region 62, 63.

These projections 75 penetrate when the riveting nut 60 is pushed into the battery housing part 30, 32 and lead to a good electrical contact between the riveting nut 60 and the battery housing part 30 32.

The projections 75 can be used as an alternative to the projections 67 or else in addition, in order to produce the electrical contact.

FIG. 7 shows an embodiment according to FIG. 6, in which five projections 75 are provided.

Of course, numerous modifications are possible within the scope of the present invention.

What is claimed is:

1. A battery housing for receiving a traction battery, the battery housing comprising:
a battery housing part and a cover which together define a receiving region for the traction battery,
the cover having a contact surface and the battery housing part having a contact counter surface, wherein the contact surface of the cover and the contact counter surface of the battery housing part lie against each other in a contact region, and
wherein a shielding part extends into a shielding region, the shielding region being arranged between the receiving region and the contact region in order to bring about shielding in the shielding region.

2. The battery housing as claimed in claim 1, in which the shielding part is configured as a shielding plate.

3. The battery housing as claimed in claim 1, in which the shielding part is fixedly connected to the cover in order to position the shielding part in a predetermined manner in the battery housing when the cover is fastened to the battery housing part.

4. The battery housing as claimed in claim 1, in which the shielding part is fixedly connected to the battery housing part in order to position the shielding part in a predetermined manner in the battery housing when the cover is fastened to the battery housing part.

5. The battery housing as claimed in claim 1, in which the shielding part is electrically conductively connected to the battery housing.

6. The battery housing as claimed in claim 1, in which the shielding part has a free end which lies against the battery housing.

7. The battery housing as claimed in claim 1, in which the shielding part is configured at least in regions as a perforated plate.

8. The battery housing as claimed in claim 1, in which the cover and the battery housing part are connected to each other by an adhesive connection with an adhesive.

9. The battery housing as claimed in claim 1, in which the battery housing part and the cover are at least partially metallic.

10. A battery housing for receiving a traction battery, the battery housing comprising:
a battery housing part and a cover which together define a receiving region for the traction battery,
at least one riveting nut with a head and a tubular region, which riveting nut is fastened to the battery housing part and is electrically conductively connected thereto, and
wherein the cover is fastened to the battery housing part via a screw fastened to the riveting nut.

11. The battery housing as claimed in claim 10, in which the riveting nut has at least one projection on a side of the head which faces away from the tubular region, which projection is provided to penetrate the cover during the fastening of the riveting nut and to lead to an electrically conductive contact between the riveting nut and the cover.

12. The battery housing as claimed in claim 10, in which the riveting nut has at least one projection on a side of the head which faces the tubular region, which projection is provided to penetrate the battery housing part during the fastening of the riveting nut and to lead to an electrically conductive contact between the riveting nut and the battery housing part.

13. The battery housing as claimed in claim 10, in which projections are provided on the tubular region of the riveting nut, which projections are configured to penetrate the battery housing part during pushing of the riveting nut in the battery housing part and to lead to an electrically conductive contact between the riveting nut and the battery housing part.

14. The battery housing as claimed in claim 13, in which the projections are cutting edges.

15. The battery housing as claimed in claim 10, further comprising a shielding part.

16. The battery housing as claimed in claim 15, in which the shielding part is fixedly connected to the cover in order to position the shielding part in a predetermined manner in the battery housing when the cover is fastened to the battery housing part.

17. The battery housing as claimed in claim 15, in which the shielding part is fixedly connected to the battery housing part in order to position the shielding part in a predetermined manner in the battery housing when the cover is fastened to the battery housing part.

18. The battery housing as claimed in claim 15, in which the shielding part is electrically conductively connected to the battery housing.

19. The battery housing as claimed in claim 15, in which the shielding part has a free end which lies against the battery housing.

20. The battery housing as claimed in claim 1, which is connected to a body of a vehicle.
